(19) United States
(12) Patent Application Publication
(10) Pub. No.: US 2024/0072984 A1
(43) Pub. Date: Feb. 29, 2024

(54) METHODS AND APPARATUSES OF ENHANCED MECHANISM FOR DEACTIVATED OR DORMANT SN

(71) Applicant: Lenovo (Beijing) Limited, Beijing (CN)

(72) Inventors: Lianhai Wu, Beijing (CN); Congchi Zhang, Shanghai (CN); Mingzeng Dai, Shanghai (CN); Ran Yue, Beijing (CN); Le Yan, Shanghai (CN)

(73) Assignee: Lenovo (Beijing) Limited, Beijing (CN)

(21) Appl. No.: 18/271,708

(22) PCT Filed: Jan. 12, 2021
(86) PCT No.: PCT/CN2021/071325

§ 371 Date: Jul. 11, 2023

(51) Int. Cl. H04L 5/00; H04W 76/22

(52) U.S. Cl. CPC H04L 5/0098; H04W 76/22

(57) ABSTRACT

Embodiments of the present application relate to methods and apparatuses of an enhanced mechanism for a deactivated or dormant secondary node (SN) in a multi-radio dual connectivity (MR-DC) scenario under a 3rd Generation Partnership Project (3GPP) 5G New Radio (NR) system or the like. According to an embodiment of the present application, a method may be performed by a user equipment (UE) and can include: receiving configuration information from a serving cell, wherein the configuration information indicates to the UE an activated or a deactivated state of a secondary node (SN); and in response to receiving the configuration information indicating the activated state of the SN of the UE, receiving a deactivation indication or determining an expiry of a timer associated with deactivating the SN of the UE.

### TECHNICAL FIELD

Embodiments of the present application generally relate to wireless communication technology, especially to methods and apparatuses of an enhanced mechanism for a deactivated or dormant secondary node (SN) in a multi-radio dual connectivity (MR-DC) scenario.

### BACKGROUND

Next generation radio access network (NG-RAN) supports a MR-DC scenario. In a MR-DC scenario, a user equipment (UE) with multiple transceivers may be configured to utilize resources provided by two different nodes connected via non-ideal backhauls. Wherein one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3rd Generation Partnership Project (3GPP) standard documents), and at least the MN is connected to the core network.

In general, there are three types of states defined for a SN in a MR-DC scenario, i.e., an activated state, a deactivated state, and a dormant state. In some cases, a deactivated state and a dormant state refer to the same state of a SN. Currently, details regarding an enhanced mechanism for a deactivated or dormant SN in a MR-DC scenario have not been discussed in 3GPP 5G technology yet.

### SUMMARY

Some embodiments of the present application provide a method for wireless communications. The method may be performed by a radio access network (RAN) node, e.g., a MN or a SN. The method includes: in response to a SN deactivation procedure being initiated, transmitting a deactivation indication to a UE, wherein the deactivation indication is carried in at least one of: a radio resource control (RRC) message, a deactivation medium access control (MAC) control elements (CE), and a dormancy MAC CE; and in response to a SN activation procedure being initiated, transmitting an activation indication to the UE, wherein the activation indication is carried in at least one of the RRC message and an activation MAC CE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a RAN node.

Some embodiments of the present application provide a further method for wireless communications. The method may be performed by a UE. The method includes: receiving configuration information from a serving cell, wherein the configuration information indicates to the UE an activated state or a deactivated state of a secondary node (SN) of the UE; and in response to receiving the configuration information indicating the activated state of the SN of the UE, receiving a deactivation indication or determining an expiry of a timer associated with deactivating the SN of the UE.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a UE.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of a wireless communication system in accordance with some embodiments of the present application;

FIG. 1B illustrates a network side protocol termination options for MCG, SCG and split bearers in a MR-DC scenario with 5GC (NGEN-DC, NE-DC and NR-DC) in accordance with 3GPP standard document TS37.340;

FIG. 2 illustrates a flow chart of a method for transmitting a deactivation or activation indication in accordance with some embodiments of the present application;

FIG. 3 illustrates an exemplary flowchart of transmitting a deactivation indication in accordance with some embodiments of the present application;

FIG. 4 illustrates a further exemplary flowchart of transmitting a deactivation indication in accordance with some embodiments of the present application;

FIG. 5 illustrates another exemplary flowchart of transmitting a deactivation indication in accordance with some embodiments of the present application;

FIG. 6 illustrates an additional exemplary flowchart of transmitting a deactivation indication in accordance with some embodiments of the present application;

FIG. 7 illustrates yet another exemplary flowchart of transmitting an activation indication in accordance with some embodiments of the present application;

FIG. 8 illustrates yet an additional exemplary flowchart of transmitting an activation indication in accordance with some embodiments of the present application;

FIG. 9 illustrates a flow chart of a method for configuring a SN state in a UE in accordance with some embodiments of the present application; and

FIG. 10 illustrates an exemplary block diagram of an apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

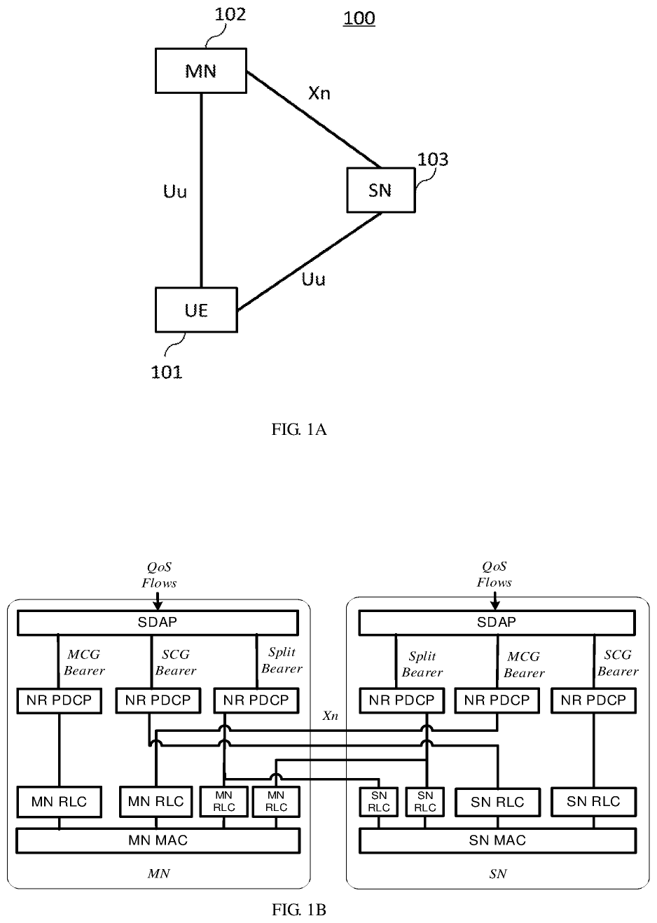

FIG. 1A illustrates a schematic diagram of a wireless communication system in accordance with some embodiments of the present application.

As shown in FIG. 1A, the wireless communication system 100 may be a dual connectivity system 100, including at least one UE 101, at least one MN 102, and at least one SN 103. In particular, the dual connectivity system 100 in FIG. 1A includes one shown UE 101, one shown MN 102, and one shown SN 103 for illustrative purpose. Although a specific number of UEs 101, MNs 102, and SNs 103 are depicted in FIG. 1A, it is contemplated that any number of UEs 101, MNs 102, and SNs 103 may be included in the wireless communication system 100.

Referring to FIG. 1A, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1A). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more SCells. The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

From a perspective of a network, each bearer (a MCG bearer, a SCG bearer, and a split bearer) can be terminated either in a MN or in a SN. As specified in 3GPP standard document TS37.340, network side protocol termination options are shown in FIG. 1B for a MR-DC with 5GC (NGEN-DC, NE-DC and NR-DC). In general, a radio bearer configured with a service data adaptation protocol (SDAP) and a packet data convergence protocol (PDCP) entity located in the MN or the SN is considered as “a MN terminated radio bearer” or “a SN terminated radio bearer”. A radio bearer configured with a radio link control (RLC) and a medium access control (MAC) entity located in MN or SN is considered as a MCG bearer or a SCG bearer. Thus, there are six types of radio bearers which can be configured in a MR-DC scenario: (1) a SN terminated MCG bearer; (2) a SN terminated SCG bearer; (3) a MN terminated MCG bearer; (4) a MN terminated SCG bearer; (5) a MN terminated split bearer; and (6) a SN terminated split bearer.

FIG. 1B illustrates a network side protocol termination options for MCG, SCG and split bearers in a MR-DC scenario with 5GC (NGEN-DC, NE-DC and NR-DC) in accordance with 3GPP standard document TS37.340. As shown in FIG. 1B, there are six types of radio bearers which can be configured in a MR-DC scenario for a 5GC (5G core network) case:
(1) MN terminated MCG bearer, with SDAP and PDCP, RLC, and MAC located at MN.
(2) MN terminated SCG bearer, with SDAP and PDCP located at MN while RLC and MAC located at SN.
(3) MN terminated split bearer, with SDAP and PDCP located at MN while one RLC leg at MN and another RLC leg at SN.
(4) SN terminated split bearer, with (SDAP and) PDCP located at SN while one RLC leg at MN and another RLC leg at SN
(5) SN terminated MCG bearer, with SDAP and PDCP located at SN while RLC and MAC located at MN.
(6) SN terminated SCG bearer, with SDAP and PDCP, RLC, and MAC located at SN.

In general, agreements of 3GPP standard documents regarding a SCell activation procedure or a SCell deactivation procedure are as follows. To enable reasonable UE battery consumption when carrier aggregation (CA) is configured, an activation/deactivation mechanism of Cells is supported. When a SCell is deactivated, a UE does not need to receive the corresponding physical downlink control channel (PDCCH) or physical downlink shared channel (PDSCH), cannot transmit in the corresponding uplink, nor is it required to perform channel quality indicator (CQI) measurements. Conversely, when a SCell is active, the UE shall receive PDSCH and PDCCH (if the UE is configured to monitor PDCCH from this SCell) and is expected to be able to perform CQI measurements.

As specified in 3GPP Release 17 Work Item on NR support of efficient SCG activation or deactivation procedure in a MR-DC scenario, in EN-DC deployment, power consumptions of a UE and a network is a big issue, due to simultaneously maintaining two radio links. In some cases, a NR UE's power consumption is 3 to 4 times higher than a LTE UE's power consumption. In EN-DC deployment, a MN provides the basic coverage. When a UE's data rate requirement changes dynamically, e.g., from high to low, a SN is worth considering to be (de)activated to save energy consumptions of the network and the UE.

A SN (de)activation procedure can be initiated by a MN, a SN, or a UE. Currently, according to agreements of 3GPP standard documents, there are following three ways, i.e., Way #1, Way #2, and Way #3, to activate and deactivate the SN.
Way #1: a SN may be activated or deactivated upon SCell configuration. In Way #1, on one hand, a MN may configure a UE to set a SN's state in SN relevant configuration information in the UE as an activated or deactivated state, and then, the MN informs the SN. On the other hand, a SN may configure a UE. In particular, if SRB3 is configured, the SN transmits (de)activation indication to the UE directly; and if SRB3 is not configured and if the SN transmits an (de)activation indication to the UE for setting a SN's state in SN relevant configuration information in the UE as an activated state, the SN needs to transmit RRC Reconfiguration message contained in the DLInformationTransferMRDC message via the MN.
Way #2: a SN may be activated or deactivated via a SN activation or deactivation MAC CE. A SN activation MAC CE is only transmitted by a MN. A SN deactivation MAC CE can be transmitted by a MN and a SN.
Way #3: a SN may be deactivated upon an expiry of a timer for a deactivated or dormant SN. The timer for a deactivated or dormant SN may also be named as a timer associated with deactivating SN or the like.

Currently, more details regarding a SN (de)activation procedure are unclear, and specific enhanced mechanisms are needed to (de)activate a SN in an efficient way. Some embodiments of the present application provide a SN (de)activation mechanism in a MR-DC scenario in 3GPP 5G NR system or the like in an efficient way.

For example, in some embodiments, if a SN deactivation procedure is initiated by a SN and the SN transmits a deactivation MAC CE to a UE, the SN needs to indicate to the MN using a Xn interface before indicating to the UE to deactivate the SN. A SN may initiate a SN deactivation procedure based on a trigger condition configured by a MN.

In some other embodiments, a SN deactivation procedure is initiated by a SN and the SN transmits a deactivation indication to the MN, and the MN transmits the deactivation indication to a UE, to configure a SN's state in SN relevant configuration information in the UE as a deactivated or dormant state, via a MAC CE or a RRC reconfiguration message. These embodiments provide new MAC CE(s) for the SN (de)activation procedure.

Some embodiments of the present application provide solutions to handle a case in which there is the buffered data when a SN is configured as a deactivated or dormant state. Some embodiments of the present application provide solutions to handle a case of UL data arrival at a SN deactivated or dormant state in SN relevant configuration information in the UE. Some embodiments of the present application provide solutions to handle a packet data convergence protocol (PDCP) duplication and split radio bearer (RB) when a SN's state in SN relevant configuration information in the UE is configured as deactivated or dormant.

More details regarding embodiments of the present application will be illustrated in the following text in combination with the appended drawings. Following definitions are assumed in the embodiments of the present application:
Fast MCG link recovery: in a MR-DC scenario, a RRC procedure where the UE sends an MCG Failure Information message to the MN via the SCG upon the detection of a radio link failure on the MCG.
Master Cell Group: in a MR-DC scenario, a group of serving cells associated with the Master Node, comprising of the SpCell (PCell) and optionally one or more SCells.
Secondary Cell Group: in a MR-DC scenario, a group of serving cells associated with the Secondary Node, comprising of the SpCell (PSCell) and optionally one or more SCells.
Secondary node: in a MR-DC scenario, the radio access node, with no control plane connection to the core network, providing additional resources to the UE. It may be an en-gNB (in EN-DC), a Secondary ng-eNB (in NE-DC) or a Secondary gNB (in NR-DC and NGEN-DC).
SCG bearer: in a MR-DC scenario, a radio bearer with an RLC bearer (or two RLC bearers, in case of CA packet duplication in an E-UTRAN cell group, or up to four RLC bearers in case of CA packet duplication in a NR cell group) only in the SCG.
SpCell: a primary cell of a master or secondary cell group.
signaling radio bearer (SRB) 3: in EN-DC, NGEN-DC and NR-DC, a direct SRB between the SN and the UE.
Split bearer: in a MR-DC scenario, a radio bearer with RLC bearers both in MCG and SCG.

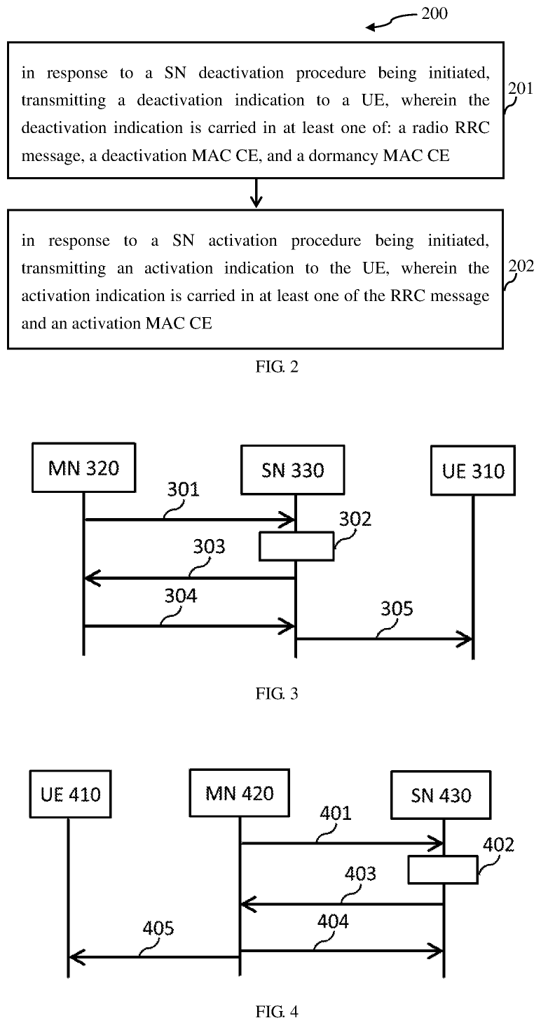

FIG. 2 illustrates a flow chart of a method for transmitting a deactivation or activation indication in accordance with some embodiments of the present application. The exemplary method 200 in the embodiments of FIG. 2 may be performed a RAN node, e.g.:
a MN (e.g., MN 102, MN 320, MN 420, MN 520, MN 620, MN 720, or MN 820 as shown and illustrated in any of FIGS. 1A and 3-8); or
a SN (e.g., SN 103, SN 330, SN 430, SN 530, SN 630, SN 730, or SN 830 as shown and illustrated in any of FIGS. 1A and 3-8); or
a RAN node in a non-MR-DC scenario.

Although described with respect to a RAN node, it should be understood that other device(s) may be configured to perform the method as shown and illustrated in FIG. 2. The embodiments of FIG. 2 assume that a MN and a SN may be combined in any one of EN-DC, NGEN-DC, NE-DC, and NR-DC scenarios.

In the exemplary method 200 as shown in FIG. 2, in operation 201, if a SN deactivation procedure is initiated, a RAN node transmits a deactivation indication to a UE. The deactivation indication is carried in at least one of: a radio RRC message, a deactivation MAC CE, and a dormancy MAC CE. A deactivation MAC CE may also be named as a MAC CE for deactivation or the like. A dormancy MAC CE may also be named as a MAC CE for dormancy, a dormant MAC CE, or the like.

In operation 202, if a SN activation procedure being initiated, the RAN node transmits an activation indication to the UE. The activation indication is carried in at least one of the RRC message and an activation MAC CE. An activation MAC CE also be named as a MAC CE for activation or the like.

According to some embodiments, for the deactivation MAC CE, the dormancy MAC CE, and the activation MAC CE, if one single SN is configured to the UE, a content field of each of these MAC CEs is zero bit; and if two or more SNs are configured to the UE, an index of each SN within the two or more SNs is included in each of these MAC CEs. For example, regarding the index of each SN included in each MAC CE, a value “1” indicates that a corresponding SN is deactivated, and a value “0” indicates that a corresponding SN is activated. For instance, each MAC CE includes a bit map, and each bit in the bit map corresponds to an index of each SN within the configured two or more SNs.

According to some embodiments, if the SN deactivation procedure is initiated, the RAN node transmits, to the UE, configuration information for configuring a SN state in the UE as a deactivated state or a dormant state. For example, a SN state in SN relevant configuration information in the UE is configured by the transmitted configuration information as a deactivated state or a dormant state.

In some embodiments, if the RAN node is a MN, the MN receives, from the UE, information regarding data buffered in the UE. In an embodiment, the MN may receive, from the UE, a response for the deactivation indication, which includes the information regarding data buffered in the UE.

In a further embodiment, the MN may receive, from the UE, an ID of a bearer and/or information regarding an expiry of a timer associated with deactivating SN. The timer may also be named as “a timer for deactivated or dormant SN” or the like. In one example, the MN may transmit, to both a SN and the UE, information regarding reconfiguring a SCG data radio bearer (DRB) as a MCG DRB. In a further example, the MN further transmits, to a SN, information associated with a secondary cell group buffer status report (SCG-BSR).

The exemplary method 200 as shown in FIG. 2 may be performed by a SN in a MR-DC scenario in following embodiments.

In particular, in some embodiments, the SN may transmit, to a MN, a request message which is for deactivating the SN or activating the SN. For instance, the request message includes bearer information in response to data arrival at the SN.

In one embodiment, after transmitting the request message, the SN receives a acknowledge message from the MN, which indicates that the MN accepts the request message. In a further embodiment, if the request message is associated with the SN activation procedure, after transmitting the request message, the SN receives, from the MN, a reject message or configuration information relating to reconfiguring a SCG bearer as a MCG bearer. Upon receiving the reject message or the configuration information, the SN performs data forwarding to the MN.

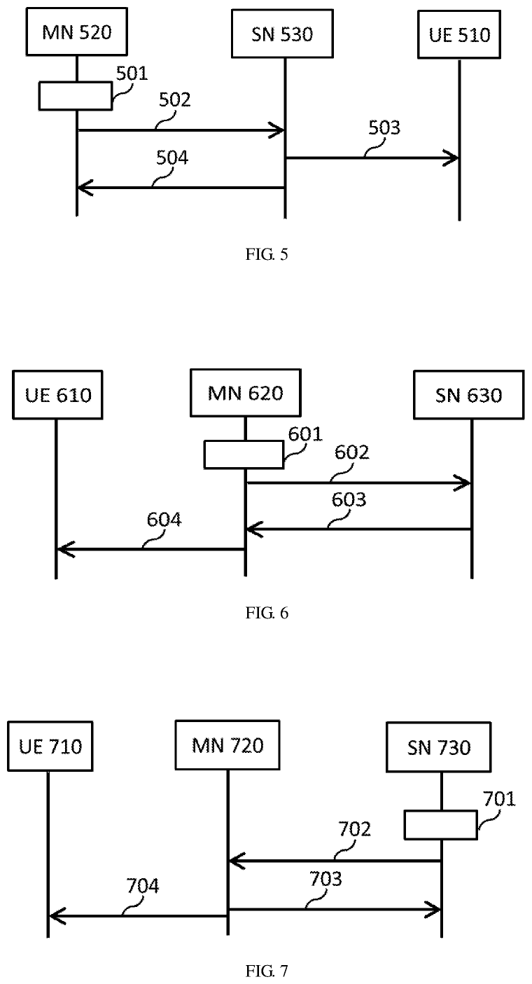

In some other embodiments, the SN receives, from a MN in the MR-DC scenario, a request message for deactivating the SN or activating the SN. After receiving the request message from the MN, the SN is not allowed to reject the second request message from the MN. A specific example is described in FIG. 5.

In some additional embodiments, the SN receives, from a MN, configuration information regarding a trigger condition for deactivating the SN. Upon meeting the trigger condition for deactivating the SN, the SN initiates the SN deactivation procedure. A trigger condition for deactivating the SN configured by a MN may be: a data volume within a time duration of the SN is equal to or less than a threshold; or a reference signal received power (RSRP) for a primary secondary cell (PSCell) of the SN is equal to or less than another threshold.

The exemplary method 200 as shown in FIG. 2 may be performed by a MN in a MR-DC scenario in following embodiments.

In particular, in some embodiments, the MN transmits, to a SN, configuration information regarding the trigger condition for deactivating the SN, which may be: a data volume within a time duration of the SN is equal to or less than a threshold; or a RSRP for a PSCell of the SN is equal to or less than another threshold.

In some other embodiments, the MN receives, from a SN, a request message for deactivating the SN or activating the SN. In a case that this request message is for activating the SN, the MN may determine whether to accept or reject the request message. If the MN accepts the request message, the MN may transmit the activation indication to the UE; and if the MN rejects the request message, the MN may transmit a reject indication to the SN. If the MN rejects the request message, the MN may transmit, to both the SN and the UE, information relating to reconfiguring a SCG DRB as a MCG DRB.

In some additional embodiments, the MN transmits, to a SN, a request message for deactivating the SN or activating the SN. Then, the MN may receive an acknowledge message from the SN, which indicates that the SN accepts the request message.

Details described in all other embodiments of the present application (for example, details of transmitting a deactivation or activation indication in a MR-DC scenario) are applicable for the embodiments of FIG. 2. Moreover, details described in the embodiments of FIG. 2 are applicable for all the embodiments of FIGS. 1 and 3-10.

FIG. 3 illustrates an exemplary flowchart of transmitting a deactivation indication in accordance with some embodiments of the present application. Generally, in the embodiments of FIG. 3, a SN deactivation procedure is initiated by a SN, and the SN transmits a deactivation MAC CE to UE. The SN needs to indicate to a MN using a Xn interface before indicating to the UE to set a SN's state in SN relevant configuration information in the UE as deactivated or dormant.

As shown in FIG. 3, in step 301, MN 320 (e.g., MN 102 as illustrated and shown in FIG. 1A) transmits, to SN 330 (e.g., SN 103 as illustrated and shown in FIG. 1A), a trigger condition for deactivating SN 330. The trigger condition could be one of:
(1) Data volume within one time duration of SN 330 is equal to or less than one configured threshold; and
(2) Reference Signal Received Power (RSRP) for PSCell of SN 330 is equal to or less than a further configured threshold.

In step 302, a SN deactivation procedure is initiated by SN 330. For example, SN 330 initiates the SN deactivation procedure based on meeting the trigger condition configured by MN 320.

In step 303, SN 330 transmits a request to MN 320 using a Xn interface, before SN 330 transmits a deactivation indication to UE 310 (e.g., UE 101 as illustrated and shown in FIG. 1A). In step 304, MN 320 transmits an acknowledge message to SN 330 via a Xn interface.

In step 305, SN 330 transmits a deactivation indication to UE 310 via a RRC message or a MAC CE. For instance, SN 330 may transmit the deactivation indication by one of:
(1) A RRC reconfiguration message, which includes “sNodeState” IE.
(2) A deactivation MAC CE or a dormancy MAC CE. In some embodiments, one new logical channel id (LCID) is reserved for the deactivation or dormancy MAC CE. The content field of the deactivation or dormancy MAC CE is zero bit. Namely, only the header of the deactivation or dormancy MAC CE is included for transmission.

After UE 310 receives the deactivation indication from SN 330, UE 310 configures a SN's state in SN relevant configuration information in UE 310 as deactivated or dormant state.

In some embodiments, when the SN's state in UE 310 is configured as deactivated or dormant, UE 310 may suspend or disable a PDCP duplication. In some other embodiments, when the SN's state in UE 310 is configured as deactivated or dormant, UE 310 may suspend or disable a split radio bearer (RB). Alternatively, UE 310 may set a threshold associated with the data split as infinity. For example, ul-DataSplitThreshold can be considered or set as infinity.

Details described in all other embodiments of the present application (for example, details of transmitting a deactivation indication) are applicable for the embodiments of FIG. 3. Moreover, details described in the embodiments of FIG. 3 are applicable for all the embodiments of FIGS. 1, 2, and 4-10.

FIG. 4 illustrates a further exemplary flowchart of transmitting a deactivation indication in accordance with some embodiments of the present application. Generally, in the embodiments of FIG. 4, a SN deactivation procedure is initiated by a SN and the SN indicates to a MN. The MN transmits a deactivation indication to a UE via a MAC CE or a RRC reconfiguration message, to set a SN's state in SN relevant configuration information in the UE as deactivated or dormant.

As shown in FIG. 4, in step 401, MN 420 (e.g., MN 102 as illustrated and shown in FIG. 1A) transmits, to SN 430 (e.g., SN 103 as illustrated and shown in FIG. 1A), a trigger condition for deactivating SN 430. The trigger condition could be one of:
(1) Data volume within one time duration of SN 430 is equal to or less than one configured threshold; and
(2) Reference Signal Received Power (RSRP) for PSCell of SN 430 is equal to or less than a further configured threshold.

In step 402, a SN deactivation procedure is initiated by SN 430. For example, SN 430 initiates the SN deactivation procedure based on meeting the trigger condition configured by MN 420.

In step 403, SN 430 transmits a request to MN 420 using a Xn interface. In step 404, MN 420 transmits an acknowledge message to SN 430 via a Xn interface.

In step 405, MN 420 transmits a deactivation indication to UE 410 (e.g., UE 101 as illustrated and shown in FIG. 1A) via a RRC message or a MAC CE. For instance, MN 420 may transmit the deactivation indication by one of:
(1) A RRC reconfiguration message, which includes “sNodeState” IE.
(2) A deactivation MAC CE or a dormancy MAC CE. One new LCID is reserved for the deactivation MAC CE or the dormancy MAC CE.
   In some embodiments, if only one single SN is configured, the content field of the deactivation or dormancy MAC CE is zero bit. Namely, only the header of the deactivation or dormancy MAC CE is included for transmission.
   In some other embodiments, if two or more SNs are configured, the header of the deactivation or dormancy MAC CE is included for transmission. In addition, an index of each SN within the two or more SNs is included in the deactivation or dormancy MAC CE. For instance, the deactivation or dormancy MAC CE includes a bit map, and each bit in the bit map corresponds to an index of each SN within the configured two or more SNs. In one example, a SNi field in the deactivation or dormancy MAC CE may be set to 1, to indicate that this SN is deactivated; and the SNi field may be set to 0, to indicate that this SN is activated, wherein SNi represents that the index of the corresponding SN is i.

After UE 410 receives the deactivation indication from MN 420, UE 410 configures a SN's state in SN relevant configuration information in UE 410 as deactivated or dormant state.

Details described in all other embodiments of the present application (for example, details of transmitting a deactivation indication) are applicable for the embodiments of FIG. 4. Moreover, details described in the embodiments of FIG. 4 are applicable for all the embodiments of FIGS. 1-3 and 5-10.

FIG. 5 illustrates another exemplary flowchart of transmitting a deactivation indication in accordance with some embodiments of the present application. Generally, in the embodiments of FIG. 5, a SN deactivation procedure is initiated by a MN and the MN indicates to the SN to deactivate the SN. Then, the SN transmits a deactivation indication to a UE via a MAC CE or a RRC reconfiguration message, to set a SN's state in SN relevant configuration information in the UE as deactivated or dormant. In the embodiments of FIG. 5, the SN is not allowed to reject the request from the MN.

As shown in FIG. 5, in step 501, a SN deactivation procedure is initiated by MN 520 (e.g., MN 102 as illustrated and shown in FIG. 1A).

In step 502, MN 520 transmits a request to SN 530 (e.g., SN 103 as illustrated and shown in FIG. 1A) using a Xn interface. SN 530 is not allowed to reject the request from MN 520.

In step 503, SN 530 transmits a deactivation indication to UE 510 (e.g., UE 101 as illustrated and shown in FIG. 1A) via a RRC message or a MAC CE. For example, SN 530 transmits the deactivation indication by one of:
(1) A RRC reconfiguration message, which includes “sNodeState” IE.
(2) A deactivation MAC CE or a dormancy MAC CE. In some embodiments, one new LCID is reserved for the deactivation MAC CE or the dormancy MAC CE. The content field of the deactivation or dormancy MAC CE is zero bit. Namely, only the header of the deactivation or dormancy MAC CE is included for transmission.

In step 504, SN 530 transmits a acknowledge message to MN 520 via a Xn interface.

Details described in all other embodiments of the present application (for example, details of transmitting a deactivation indication) are applicable for the embodiments of FIG. 5. Moreover, details described in the embodiments of FIG. 5 are applicable for all the embodiments of FIGS. 1-4 and 6-10.

FIG. 6 illustrates an additional exemplary flowchart of transmitting a deactivation indication in accordance with some embodiments of the present application. Generally, in the embodiments of FIG. 6, a SN deactivation procedure is initiated by a MN and the MN indicates to the SN to deactivate the SN. Then, the SN transmits a deactivation indication to a UE via a MAC CE or a RRC reconfiguration message, to set a SN's state in SN relevant configuration information in the UE as deactivated or dormant.

As shown in FIG. 6, in step 601, a SN deactivation procedure is initiated by MN 620 (e.g., MN 102 as illustrated and shown in FIG. 1A).

In step 602, MN 620 transmits a request to SN 630 (e.g., SN 103 as illustrated and shown in FIG. 1A) using a Xn interface. In step 603, SN 630 transmits an acknowledge message to MN 620 via a Xn interface.

In step 604, MN 620 transmits a deactivation indication to UE 610 (e.g., UE 101 as illustrated and shown in FIG. 1A) via a RRC message or a MAC CE. For example, SN 630 transmits the deactivation indication by one of:
(3) A RRC reconfiguration message, which includes “sNodeState” IE.
(4) A deactivation MAC CE or a dormancy MAC CE. One new LCID is reserved for the deactivation MAC CE or the dormancy MAC CE.
   In some embodiments, if only one single SN is configured, the content field of the deactivation or dormancy MAC CE is zero bit. Namely, only the header of the deactivation or dormancy MAC CE is included for transmission.
   In some other embodiments, if two or more SNs are configured, the deactivation or dormancy MAC CE include the header of the deactivation or dormancy MAC CE as well as an index of each SN within the two or more SNs.
      For instance, the deactivation or dormancy MAC CE includes a bit map, and each bit in the bit map corresponds to an index of each SN within the configured two or more SNs. In one example, a SNi field in the deactivation or dormancy MAC CE may be set to 1, to indicate that this SN is deactivated; and the SNi field may be set to 0, to indicate that this SN is activated, wherein SNi represents that the index of the corresponding SN is i.

After UE 610 receives the deactivation indication from MN 620, UE 610 configures a SN's state in SN relevant configuration information in UE 610 as deactivated or dormant state.

Details described in all other embodiments of the present application (for example, details of transmitting a deactivation indication) are applicable for the embodiments of FIG. 6. Moreover, details described in the embodiments of FIG. 6 are applicable for all the embodiments of FIGS. 1-5 and 7-10.

FIG. 7 illustrates yet another exemplary flowchart of transmitting an activation indication in accordance with some embodiments of the present application. Generally, in the embodiments of FIG. 7, a SN activation procedure is initiated by a SN, and the SN needs to indicate to a MN using Xn interface. Then, the MN indicates to a UE via MAC CE or RRC message, to set a SN's state in SN relevant configuration information in the UE as activated.

As shown in FIG. 7, in step 701, a SN deactivation procedure is initiated by SN 730 (e.g., SN 103 as illustrated and shown in FIG. 1A). For example, SN 730 initiates the SN deactivation procedure upon receiving data from a CN.

In step 702, SN 730 transmits a request to MN 720 (e.g., MN 102 as illustrated and shown in FIG. 1A) using a Xn interface. The request may include the bearer information associated the data arrival at SN 730.

In some embodiments, if MN 720 accepts the request from SN 730, in step 703, MN 720 transmits an acknowledge message to SN 730 via a Xn interface. Then, in step 704, MN 720 transmits an activation indication to UE 710 (e.g., UE 101 as illustrated and shown in FIG. 1A) via a RRC message or a MAC CE. For instance, MN 720 may transmit the activation indication by one of:
(1) A RRC reconfiguration message, which includes “sNodeState” IE.
(2) An activation MAC CE. One new LCID is reserved for the activation MAC CE. The content field of the activation MAC CE is zero bit. Namely, only the header of the activation MAC CE is included for transmission.

Alternatively, in some other embodiments, if MN 720 rejects the request from SN 730, i.e., MN 720 rejects to activate this SN, in step 703, MN 720 transmits the reject indication to the SN. Then, in step 704, MN 720 may transmit, to UE 710, information regarding reconfiguring a SCG DRB as a MCG DRB. MN 720 may also transmit, to SN 730, the information regarding reconfiguring a SCG DRB as a MCG DRB. After SN 730 receives the rejection indication or the information regarding reconfiguring the SCG DRB as the MCG DRB, SN 730 may perform data forwarding.

Details described in all other embodiments of the present application (for example, details of transmitting an activation indication) are applicable for the embodiments of FIG. 7. Moreover, details described in the embodiments of FIG. 7 are applicable for all the embodiments of FIGS. 1-6 and 8-10.

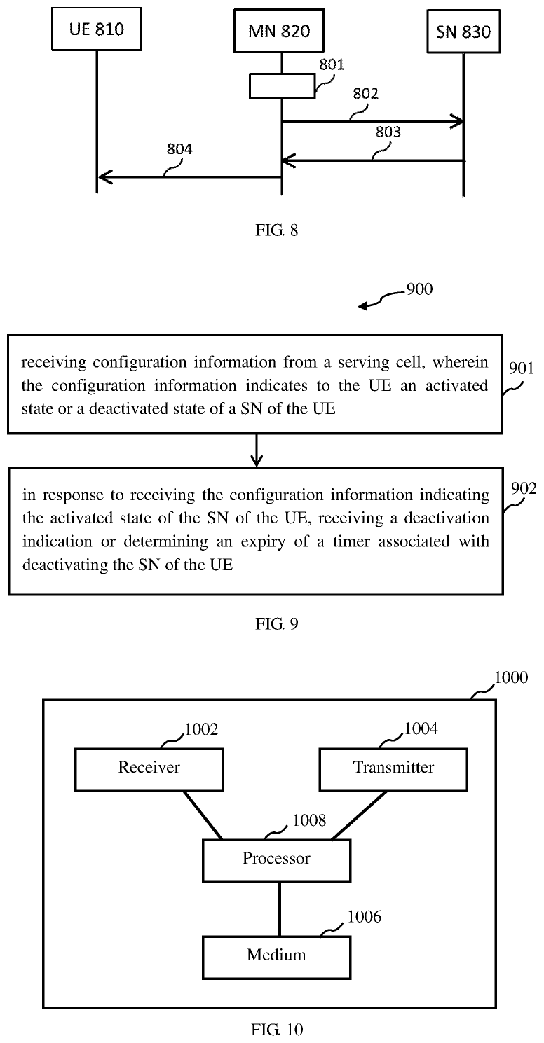

FIG. 8 illustrates yet an additional exemplary flowchart of transmitting an activation indication in accordance with some embodiments of the present application. Generally, in the embodiments of FIG. 8, a SN activation procedure is initiated by a MN, the MN needs to indicate to a SN using Xn interface WHEN the MN indicates to a UE via MAC CE or RRC message, to set a SN's state in SN relevant configuration information in the UE as activated.

As shown in FIG. 8, in step 801, a SN activation procedure is initiated by MN 820 (e.g., MN 102 as illustrated and shown in FIG. 1A). In step 802, MN 820 transmits a request to SN 830 (e.g., SN 103 as illustrated and shown in FIG. 1A) using a Xn interface. In step 803, SN 830 transmits an acknowledge message to MN 820 via a Xn interface.

In step 804, MN 820 transmits an activation indication to UE 810 (e.g., UE 101 as illustrated and shown in FIG. 1A) via a RRC message or a MAC CE. For instance, MN 820 may transmit the activation indication by one of:
(1) A RRC reconfiguration message, which includes “sNodeState” IE.
(2) An activation MAC CE. One new LCID is reserved for the activation MAC CE.
   In some embodiments, if only one single SN is configured, the content field of the activation MAC CE is zero bit. Namely, only the header of the activation MAC CE is included for transmission.
   In some other embodiments, if two or more SNs are configured, the header of the activation MAC CE is included for transmission, and an index of each SN within the two or more SNs is included in the activation MAC CE.
      For instance, the activation MAC CE includes a bit map, and each bit in the bit map corresponds to an index of each SN within the configured two or more SNs. In one example, a SNi field in the activation MAC CE may be set to 1, to indicate that this SN is activated; and the SNi field may be set to 0, to indicate that this SN is not activated, wherein SNi represents that the index of the corresponding SN is i.

Details described in all other embodiments of the present application (for example, details of transmitting an activation indication) are applicable for the embodiments of FIG. 8. Moreover, details described in the embodiments of FIG. 8 are applicable for all the embodiments of FIGS. 1-7, 9, and 10.

FIG. 9 illustrates a flow chart of a method for configuring a SN state in a UE in accordance with some embodiments of the present application.

The exemplary method 900 in the embodiments of FIG. 9 may be performed a UE, e.g., UE 101, UE 310, UE 410, UE 510, UE 610, UE 710, or UE 810 as shown and illustrated in any of FIGS. 1A and 3-8. Although described with respect to a UE, it should be understood that other device(s) may be configured to perform the method as shown and illustrated in FIG. 9.

In the exemplary method 900 as shown in FIG. 9, in operation 901, a UE receives configuration information from a serving cell. The configuration information indicates to the UE an activated state or a deactivated state of a SN of the UE. According to some embodiments, the serving cell belongs to a SN and a MN in a MR-DC scenario. That is, the UE receives configuration information from a SN or a MN, which indicates, to the UE, an activated state or a deactivated state of the SN of the UE.

In operation 902, if the UE receives the configuration information which indicates the activated state of the SN of the UE, the UE may receive a deactivation indication or determine that a timer associated with deactivating SN expires.

According to some other embodiments, the UE configures a SN state as a deactivated state and transmits, to a MN, information regarding data buffered in the UE. In an embodiment, the UE may transmit, to a MN, a response for the deactivation indication, which includes the information regarding data buffered in the UE.

In a further embodiment, the UE may transmit, to a MN, an ID of a bearer and/or information regarding the expiry of the timer associated with deactivating the SN of the UE.

In another embodiment, the UE skips the deactivation indication or the expiry of the timer associated with deactivating the SN of the UE, and transmits at least one of the ID of the bearer and the information regarding the expiry of the timer associated with deactivating the SN of the UE, e.g., to a MN. In this embodiment, The UE may receive, from a MN, information regarding reconfiguring a SCG DRB as a MCG DRB.

According to some embodiments, the UE transmits, to a MN, information indicating that data associated with a DRB is available for transmission when the SN state of the UE is in the deactivated state. In these embodiments, the UE may receive, from the MN, information regarding reconfiguring a SCG DRB as a MCG DRB.

According to some embodiments, in response to arrival of uplink data when the SN state of the UE is in the deactivated state, the UE triggers a buffer status report (BSR). If the BSR is triggered, the UE may restart the timer associated with deactivating the SN of the UE. Alternatively, if the BSR is triggered, the UE may trigger a random access (RA) procedure to transmit information to the SN. After the RA procedure is triggered, the UE may transmit the BSR.

According to some embodiments, the UE receives a deactivation indication from the SN or the MN. The deactivation indication may be carried in a RRC message, a deactivation MAC CE, and/or a dormancy MAC CE. According to some other embodiments, the UE receives an activation indication from the SN or the MN. The activation indication may be carried in a RRC message and/or an activation MAC CE. For each MAC CE of the deactivation MAC CE, the dormancy MAC CE, and the activation MAC CE, if one single SN is configured to the UE, a content field of each MAC CE is zero bit; and if two or more SNs are configured to the UE, an index of each SN within the two or more SNs is included in each of these MAC CEs.

For example, regarding the index of each SN included in each MAC CE, a value “1” indicates that a corresponding SN is deactivated, and a value “0” indicates that a corresponding SN is activated. For instance, each MAC CE includes a bit map, and each bit in the bit map corresponds to an index of each SN within the configured two or more SNs.

According to some embodiments, if the SN state in the UE is configured as a deactivated state or a dormant state, the UE may perform at least one of:
(1) suspending or disabling a packet data convergence protocol (PDCP) duplication;
(2) suspending or disabling a split radio bearer (RB); and
(3) setting a threshold associated with data split as infinity.

The following texts describe specific Embodiments 1-4 of the method as shown and illustrated in FIG. 9.

According to Embodiments 1-4, a UE and one of a MN and a SN perform the following operations. The UE may be UE 101, UE 310, UE 410, UE 510, UE 610, UE 710, or UE 810 as shown and illustrated in any of FIGS. 1A and 3-8. A MN may be MN 102, MN 320, MN 420, MN 520, MN 620, MN 720, or MN 820 as shown and illustrated in any of FIGS. 1A and 3-8. A SN may be SN 103, SN 330, SN 430, SN 530, SN 630, SN 730, or SN 830 as shown and illustrated in any of FIGS. 1A and 3-8.

### Embodiment 1

(1) Step 1: A UE accesses a network via a MR-DC scenario.
(2) Step 2: A buffer status report (BSR) in a SCG link is triggered, when UL data in the SCG link arrives. For instance, if no UL resource is available for BSR transmission, a scheduling request (SR) in the SCG link is triggered.
(3) Step 3: Before BSR or SR is transmitted, the UE receives configuration from a serving cell (e.g., a MN or a SN), which indicates to the UE a deactivated state of a SN of the UE.
(4) Step 4: The UE shall go to Option 1 or Option 2 as follows:
   Option 1: a SN's state of SN configuration information in the UE (i.e., the SN of the UE) is configured as a deactivated state according to the received configuration. The UE reports buffer information and the corresponding bearer ID to the MN. Then, the MN transmits, to the SN and the UE, information regarding reconfiguring a SCG DRB as a MCG DRB. The MN may activate the SN.
   Option 2: assuming that a response from UE is needed upon receiving the deactivation indication from the MN or the SN, after the UE receives the deactivation indication for the MN or the SN, the UE will indicate the buffered data information to the MN or the SN.

### Embodiment 2

(1) Step 1: A UE accesses a network via a MR-DC scenario. A timer associated with deactivating the SN of the UE may be configured to the UE.
(2) Step 2: The UE starts or restarts the timer associated with deactivating the SN of the UE.
   PDCCH on the activated SN indicates an uplink grant or downlink assignment; or
   a MAC PDU is transmitted in a configured uplink grant, and LBT failure indication is not received from lower layers; or
   UL PDU is not transmitted because: a listen before transmit (LBT) failure indication is received from a lower layer; or
   a MAC PDU is received in a configured downlink assignment.
(3) Step 3: The timer associated with deactivating the SN of the UE expires.
(4) Step 4: The SN's state of SN configuration information in the UE is configured as deactivated state when the timer associated with deactivating the SN of the UE expires. For example, a SN's state of SN configuration information in the UE is configured as a deactivated state when the timer associated with deactivating the SN of the UE expires, and no UL data is pending in the buffer.

Embodiment 3: this embodiment handles a case in which there is the buffered data when the SN of the UE is configured as deactivated or dormant state by a mechanism based on a timer associated with deactivating the SN of the UE.
(1) Step 1: A UE accesses a network via a MR-DC scenario. A timer associated with deactivating the SN of the UE may be configured to the UE.
(2) Step 2: The UE starts or restarts the timer associated with deactivating the SN of the UE. For example, the UE restarts the timer associated with deactivating the SN of the UE when the BSR is triggered.
(3) Step 3: A BSR in a SCG link is triggered when the UL data in the SCG link arrives. For instance, if no UL resource is available for BSR transmission, the SR in the SCG link is triggered.
(4) Step 4: The timer associated with deactivating the SN of the UE expires (before BSR or SR is transmitted).
(5) Step 5: The UE shall go to Option A and Option B as follows.
   Option A: when the timer associated with deactivating the SN of the UE expires, a SN's state of SN configuration information in the UE (i.e., the SN of the UE) is configured as a deactivated state. The UE reports buffer information, the corresponding bearer ID and an expiry of the timer associated with deactivating the SN of the UE to the MN. Then, the MN transmits, to the SN and the UE, information regarding reconfiguring a SCG DRB as a MCG DRB. The MN may activate the SN, e.g., by any of the embodiments of FIGS. 3 and 8.
      MN may also forward the SCG-BSR related information to the SN, so that the SN can schedule the UL transmission immediately after activation.
   Option B: when the timer associated with deactivating the SN of the UE expires, the UE does not configure a SN's state of SN configuration information in the UE as a deactivated state. The UE reports the buffer information, the corresponding bearer ID and the expiry of the timer associated with deactivating the SN of the UE to the MN. Then, the MN may transmit, to the SN and the UE, information regarding reconfiguring a SCG DRB as a MCG DRB. After that, the MN may indicate to the UE and the SN to deactivate the SN.

Embodiment 4: this embodiment handles a case in which UL data arrives at a SN's deactivated or dormant state
(1) Step 1: A UE accesses a network via a MR-DC scenario.
(2) Step 2: A SN's state of SN configuration information in the UE is configured as a deactivated state.
(3) Step 3: The UE shall go to Option (a) and Option (b) as follows.
   Option (a): The UE can trigger a RA procedure in the SN for transmitting a BSR triggered by the UL data arrival at a SCG radio bearer.
   Option (b): The UE indicates to a MN that the data associated with the certain SCG DRB is available for transmission.
      The MN may activate the SN using a RRC message or the MN indicates to SN.
      Alternatively, the MN can reconfigure reconfiguring a SCG DRB as a MCG DRB (i.e., reconfigure the corresponding SCG DRB to relocate to a MN link).

Details described in all other embodiments of the present application (for example, details of configuring a SN state in a UE) are applicable for the embodiments of FIG. 9. Moreover, details described in the embodiments of FIG. 9 are applicable for all the embodiments of FIGS. 1-8 and 10.

FIG. 10 illustrates an exemplary block diagram of an apparatus in accordance with some embodiments of the present application. In some embodiments of the present application, the apparatus 1000 may be a UE, a MN, or a SN, which can at least perform the method illustrated in any of FIGS. 2-9.

As shown in FIG. 10, the apparatus 1000 may include at least one receiver 1002, at least one transmitter 1004, at least one non-transitory computer-readable medium 1006, and at least one processor 1008 coupled to the at least one receiver 1002, the at least one transmitter 1004, and the at least one non-transitory computer-readable medium 1006.

Although in FIG. 10, elements such as the at least one receiver 1002, the at least one transmitter 1004, the at least one non-transitory computer-readable medium 1006, and the at least one processor 1008 are described in the singular, the plural is contemplated unless limitation to the singular is explicitly stated. In some embodiments of the present application, the at least one receiver 1002 and the at least one transmitter 1004 are combined into a single device, such as a transceiver. In certain embodiments of the present application, the apparatus 1000 may further include an input device, a memory, and/or other components.

In some embodiments of the present application, the at least one non-transitory computer-readable medium 1006 may have stored thereon computer-executable instructions which are programmed to implement the operations of the methods, for example as described in view of any of FIGS. 2-9, with the at least one receiver 1002, the at least one transmitter 1004, and the at least one processor 1008.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1. A method performed by a user equipment (UE), comprising:
receiving configuration information from a serving cell, wherein the configuration information indicates to the UE an activated state or a deactivated state of a secondary node (SN) of the UE; and
in response to receiving the configuration information indicating the activated state of the SN of the UE, receiving a deactivation indication or determining an expiry of a timer associated with deactivating the SN of the UE.

2. The method of claim 1, wherein the serving cell belongs to the SN or a master node (MN) in a multi-radio dual connectivity (MR-DC) scenario.

3. The method of claim 1, further comprising:
configuring a SN state in the UE as the deactivated state; and
transmitting, to a master node (MN), an indication of data associated with deactivating the SN of the UE.

4. The method of claim 3, further comprising transmitting, to the MN, at least one of:
an identity (ID) of a bearer; or
additional information regarding the expiry of the timer associated with deactivating the SN of the UE.

5. The method of claim 1, further comprising:
skipping the deactivation indication or the expiry of the timer associated with deactivating the SN of the UE; and
transmitting at least one of an identity (ID) of a bearer and information regarding the expiry of the timer associated with deactivating the SN of the UE.

6. The method of claim 1, further comprising:
transmitting, to a master node (MN), information indicating that data associated with a data radio bearer (DRB) is available for transmission when the SN of the UE is in the deactivated state.

7. The method of claim 6, further comprising:
receiving, from the MN, additional information regarding reconfiguring a secondary cell group (SCG) DRB as a master cell group (MCG) DRB.

8. The method of claim 1, further comprising:
in response to arrival of uplink data when the SN of the UE is in the deactivated state, triggering a buffer status report (BSR).

9. The method of claim 8, wherein, in response to the BSR being triggered, the method further comprising at least one of:
restarting the timer associated with deactivating the SN of the UE; or
triggering a random access (RA) procedure to transmit information to the SN, and transmitting the BSR during the RA procedure.

10. (canceled)

11. The method of claim 1, further comprising:
receiving a deactivation indication from the SN or a master node (MN), wherein the deactivation indication is carried in at least one of: a radio resource control (RRC) message, a deactivation medium access control (MAC) control elements (CE), or a dormancy MAC CE; or
receiving an activation indication from the SN or the MN, wherein the activation indication is carried in at least one of the RRC message or an activation MAC CE.

12-13. (canceled)

14. The method of claim 1, further comprising, in response to the SN being in the deactivated state, performing at least one of:
suspending or disabling a packet data convergence protocol (PDCP) duplication;
suspending or disabling a split radio bearer (RB); or
setting a threshold associated with data split as infinity.

15. An apparatus, comprising:
a processor; and
a memory coupled with the processor, the processor configured to cause the apparatus to:
receive configuration information from a serving cell, the configuration information indicating to the apparatus an activated state or a deactivated state of a secondary node (SN) of the apparatus; and
in response to receiving the configuration information indicating the activated state of the SN of the apparatus, receive a deactivation indication or determine an expiry of a timer associated with deactivating the SN of the apparatus.

16. The apparatus of claim 15, wherein the serving cell belongs to the SN or a master node (MN) in a multi-radio dual connectivity (MR-DC) scenario.

17. The apparatus of claim 15, wherein the processor is configured to cause the apparatus to:
configure a SN state in the apparatus as the deactivated state; and
transmit, to a master node (MN), an indication of data associated with deactivating the SN of the apparatus.

18. The apparatus of claim 15, wherein the processor is configured to cause the apparatus to:
skip the deactivation indication or the expiry of the timer associated with deactivating the SN of the apparatus; and
transmit at least one of an identity (ID) of a bearer and information regarding the expiry of the timer associated with deactivating the SN of the apparatus.

19. The apparatus of claim 15, wherein the processor is configured to cause the apparatus to transmit, to a master node (MN), information indicating that data associated with a data radio bearer (DRB) is available for transmission when the SN of the apparatus is in the deactivated state.

20. The apparatus of claim 15, wherein the processor is configured to cause the apparatus to:
receive a deactivation indication from the SN or a master node (MN), the deactivation indication received in at least one of a radio resource control (RRC) message, a deactivation medium access control (MAC) control elements (CE), or a dormancy MAC CE; or
receive an activation indication from the SN or the MN, the activation indication received in at least one of the RRC message or an activation MAC CE.

21. The apparatus of claim 15, wherein, in response to the SN being in the deactivated state, the processor is configured to cause the apparatus to at least one of:
suspend or disable a packet data convergence protocol (PDCP) duplication;
suspend or disable a split radio bearer (RB); or
set a threshold associated with data split as infinity.

22. An apparatus, comprising:
a processor; and
a memory coupled with the processor, the processor configured to cause the apparatus to:
transmit a deactivation indication to a user equipment (UE) in response to a secondary node (SN) deactivation procedure being initiated, the deactivation indication transmitted with at least one of a radio resource control (RRC) message, a deactivation medium access control (MAC) control elements (CE), or a dormancy MAC CE; and
transmit an activation indication to the UE in response to a SN activation procedure being initiated, the activation indication transmitted in at least one of the RRC message or the activation MAC CE.

23. The apparatus of claim 22, wherein the processor is configured to cause the apparatus to transmit a first request message to a master node (MN) in a multi-radio dual connectivity (MR-DC) scenario, the first request message transmitted for deactivating the SN or activating the SN.
